(19) United States
(12) Patent Application Publication
(10) Pub. No.: US 2015/0341158 A1
(43) Pub. Date: Nov. 26, 2015

(54) LOOP GAIN CALIBRATION APPARATUS FOR CONTROLLING LOOP GAIN OF TIMING RECOVERY LOOP AND RELATED LOOP GAIN CALIBRATION METHOD

(71) Applicant: Mediatek Inc., Hsin-Chu (TW)

(72) Inventors: Kuo-Ming Wu, Hsinchu County (TW); Ching-Shyang Maa, Tainan City (TW); Shu-Hsien Wang, Hsin-Chu (TW); Chung-Jung Huang, New Taipei City (TW); Guo-Hau Gau, Hsinchu County (TW); Mau-Lin Wu, Hsinchu City (TW)

(21) Appl. No.: 14/706,989

(22) Filed: May 8, 2015

Related U.S. Application Data
(60) Provisional application No. 62/002,194, filed on May 23, 2014.

(51) Int. Cl. H04L 7/00

(52) U.S. Cl. CPC H04L 7/002; H04L 7/0062

(57) ABSTRACT

A loop gain calibration apparatus has an exciting signal generator, an exciting signal extracting circuit, and a loop gain control circuit. The exciting signal generator generates a first exciting signal and injects the first exciting signal into a timing recovery loop while the timing recovery loop is operating in response to a reception signal received under a normal reception mode. The exciting signal extracting circuit extracts a second exciting signal from the timing recovery loop after the first exciting signal is injected into the timing recovery loop. The loop gain control circuit receives the first exciting signal from the exciting signal generator, receives the second exciting signal from the exciting signal extracting circuit, and controls a loop gain of the timing recovery loop according to the first exciting signal and the second exciting signal.

### CROSS REFERENCE TO RELATED APPLICATIONS

This application claims the benefit of U.S. provisional application No. 62/002,194, filed on May 23, 2014 and incorporated herein by reference.

### BACKGROUND

The disclosed embodiments of the present invention relate to timing recovery, and more particularly, to a loop gain calibration apparatus for controlling a loop gain of a timing recovery loop and a related loop gain calibration method.

Communication systems increasingly depend on digital data transmission. Digital data transmission, in turn, depends on reliable reception of transmitted data. Basically, the signals received on the receiving end must be synchronized with those from the transmission end to eliminate frequency and/or phase errors generated in a transmission channel between the transmitting end and the receiving end. In general, effective timing recovery can be used to facilitate reliable reception of transmitted data in the receiving end. More specifically, effective timing recovery can facilitate sampling instances of the received data stream at correct sampling timing phases.

For example, a timing recovery loop is implemented to control a sampling phase used by an analog-to-digital converter (ADC) in the receiving end. However, to achieve a more accurate timing error evaluation result, the timing error evaluation will introduce a longer delay, thus increasing the latency of a timing recovery circuit used in the timing recovery loop. The increased latency of the timing recovery circuit may affect the stability of the timing recovery loop. For example, on the premise that the open-loop bandwidth of the timing recovery circuit is the same, the phase margin of the timing recovery circuit becomes smaller when the latency of the timing recovery circuit becomes longer. However, a smaller phase margin of the timing recovery circuit may result in a lower stability of the timing recovery loop.

Thus, there is a need for an innovative control mechanism which is capable of tuning the open-loop bandwidth of the timing recovery circuit to thereby control the stability of the timing recovery loop.

### SUMMARY

In accordance with exemplary embodiments of the present invention, a loop gain calibration apparatus for controlling a loop gain of a timing recovery loop and a related loop gain calibration method are proposed to precisely tune the timing recovery bandwidth and phase margin.

According to a first aspect of the present invention, an exemplary loop gain calibration apparatus is disclosed. The exemplary loop gain calibration apparatus includes an exciting signal generator, an exciting signal extracting circuit, and a loop gain control circuit. The exciting signal generator is configured to generate a first exciting signal, and inject the first exciting signal into a timing recovery loop while the timing recovery loop is operating in response to a reception signal received under a normal reception mode. The exciting signal extracting circuit is configured to extract a second exciting signal from the timing recovery loop after the first exciting signal is injected into the timing recovery loop. The loop gain control circuit is configured to receive the first exciting signal from the exciting signal generator, receive the second exciting signal from the exciting signal extracting circuit, and control a loop gain of the timing recovery loop according to the first exciting signal and the second exciting signal.

According to a second aspect of the present invention, an exemplary loop gain calibration method is disclosed. The exemplary loop gain calibration method includes: while the timing recovery loop is operating in response to a reception signal received under a normal reception mode, generating a first exciting signal and injecting the first exciting signal into a timing recovery loop; after the first exciting signal is injected into the timing recovery loop, extracting a second exciting signal from the timing recovery loop; and controlling a loop gain of the timing recovery loop according to the first exciting signal and the second exciting signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a portion of a receiver of a communication system according to an embodiment of the present invention.

FIG. 2 is a diagram illustrating a simplified communication system according to an embodiment of the present invention.

FIG. 3 is a diagram illustrating a first exemplary embodiment of the exciting signal extracting circuit shown in FIG. 1.

FIG. 4 is a diagram illustrating a second exemplary embodiment of the exciting signal extracting circuit shown in FIG. 1.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

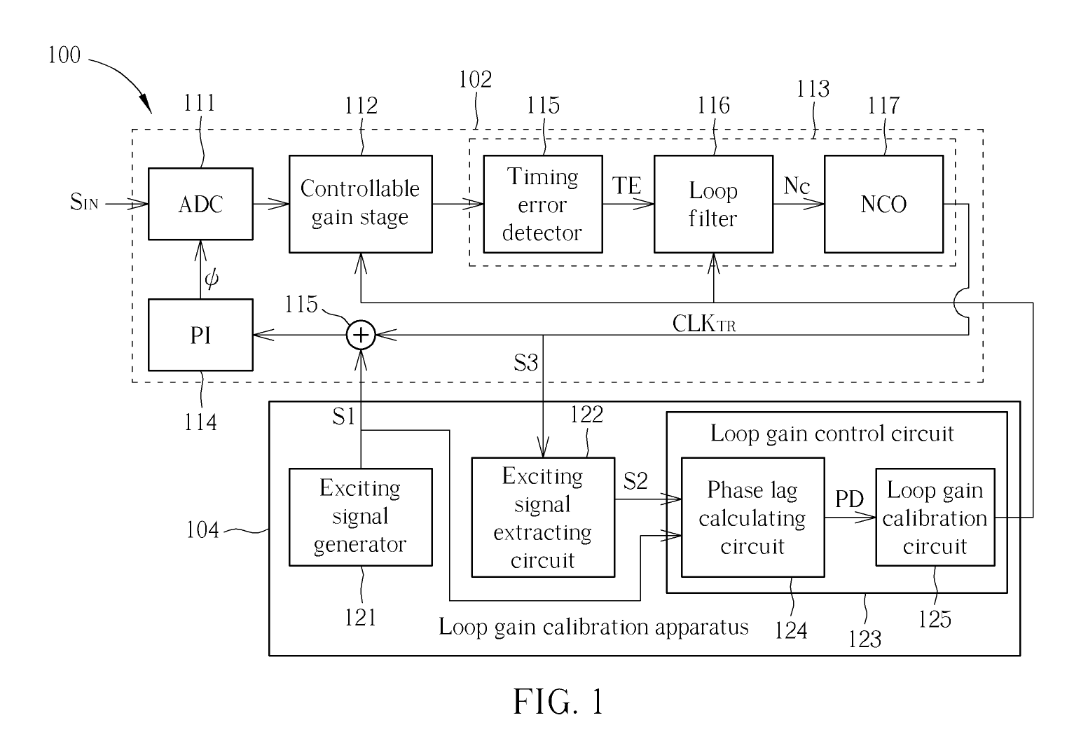

FIG. 1 is a diagram illustrating a portion of a receiver of a communication system according to an embodiment of the present invention. For example, the receiver 100 may be a receiver of a 10 GB/s communication system. In this embodiment, the receiver 100 may be a receiver of an optical fiber communication system, such as a 10 Gb/s LRM (Long Reach Multimode) fiber system developed by IEEE 802.3aq working group. As shown in FIG. 1, the receiver 100 includes a timing recovery loop 102 and a loop gain calibration apparatus 104. It should be noted that only the circuit components pertinent to the present invention are shown in FIG. 1. In practice, the receiver 100 may have additional circuit components to achieve other functions. The timing recovery loop 102 includes an analog-to-digital converter (ADC) 111, a controllable gain stage (e.g., a variable gain amplifier) 112, a timing recovery circuit 113, and a phase interpolator 114, where the timing recovery circuit 113 includes a timing error detector 115, a loop filter 116 and a numerically controlled oscillator (NCO) 117. Concerning the loop gain calibration apparatus 104, it includes an exciting signal generator 121, an exciting signal extracting circuit 122, and a loop gain control circuit 123, where the loop gain control circuit 123 includes a phase lag calculating circuit 124 and a loop gain calibration circuit 125.

The timing recovery circuit 113 is a kernel component of the timing recovery loop 102. Specifically, the timing error detector 115 estimates a timing error TE based on an output of the ADC 111. The estimated timing error TE is processed by the loop filter 116 to generate a digital control word N_{c} to the NCO 117 (which is also called Direct Digital Synthesizer (DDS)). The NCO 117 generates a clock CLK_{TR} to the phase interpolator 114 according to the digital control word N_{c}. The phase interpolator 114 refers to the clock CLK_{TR} to generate a sampling clock to the ADC 111. Since the phase of the clock CLK_{TR} is adjusted according to the estimated timing error TE, the ADC sampling phase φ is therefore adjusted to reduce the estimated timing error TE.

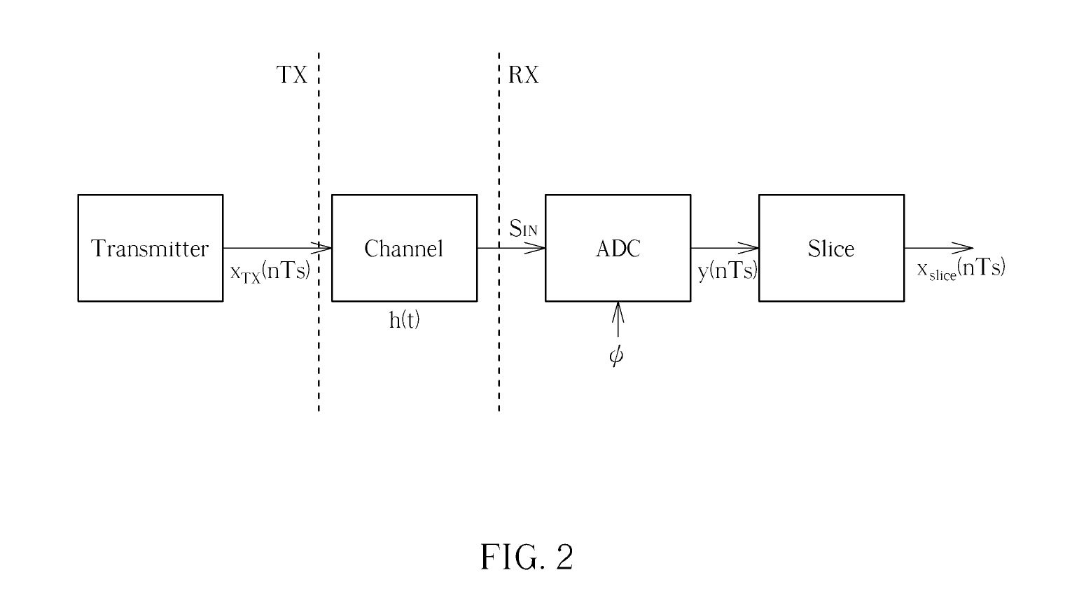

In this embodiment, the timing error detector 115 may perform timing error detection by using a Mueller-Muller algorithm, and then generate the estimated timing error TE to the loop filter 116. FIG. 2 is a diagram illustrating a simplified communication system according to an embodiment of the present invention. The transmitter in the transmitting end (TX) generates a plurality of data symbols x_{TX}(nT_{S}) in a plurality of sampling time intervals T_{S}, respectively. The sampling time interval T_{S} is equal to T, where T is the symbol time. The data symbols x_{TX}(nT_{S}) are transmitted to the receiver in the receiving end (RX) over a channel with a channel impulse response h(t). The ADC (e.g., ADC 111) samples a reception signal S_{IN} that carries the data symbols x_{TX}(nT_{S}) based on an ADC sampling phase φ, and accordingly generates a plurality of sample values y(nT_{S}) in a plurality of sampling time intervals T_{S}, respectively. Preferably, a sampling instant with the ADC sampling phase φ should be in the middle of the symbol time for obtaining the correct sample value. The Mueller-Muller algorithm may be employed to estimate deviation of the ADC sampling phase φ. For example, the timing error detector 115 may include a slicer to convert soft-decision values (i.e., sample values y(nT_{S})) into hard-decision values (i.e., sliced values x_{slice}(nT_{S})). Assuming that x_{TX}(nT_{S}) is a white sequence, the timing error TE estimated using the Mueller-Muller algorithm may be expressed as below.

E{x_{slice}(n−1)y(n)−x_{slice}(n)y(n−1)}=h(T_{S}+φ)−h(−T_{S}+φ)=TE (1)

Hence, the timing recovery loop operates in response to the estimated timing error TE to adjust the ADC sampling phase φ. The timing recovery loop does not stop adjusting the ADC sampling phase φ until the estimated timing error TE (i.e., h(T_{S}+φ)−h(−T_{S}+φ)) is equal to zero. In other words, the timing recovery loop is used to make the ADC sampling phase φ locked to a timing phase corresponding to a minimum timing error.

As can be known from above formula (1), the expected value (i.e., estimated timing error TE) is channel-dependent. Hence, different channels of the communication system may have different timing error detector gains around the locked timing phase, where the timing error detector gain is defined by a slope

$$\frac{d}{d φ} ( h ( {T}_{s} + φ ) - h ( - {T}_{s} + φ ) )$$

around the locked timing phase. Since the timing error detector gains are different for different channels, the open-loop bandwidth of the timing recovery circuit will be different for different channels.

Further, to provide more accurate sliced values x_{slice}(nT_{S}), a digital equalizer may be placed between the ADC and the slicer shown in FIG. 2. When the timing error detector 115 derives the sliced values x_{slice}(nT_{S}) from the equalizer output, the latency of the timing recovery circuit 113 is increased inevitably. As a result, the stability of the timing recovery loop 102 is degraded. To maintain the stability of the timing recovery loop 102, the phase margin of the timing recovery circuit 113 may be required to be larger than 45 degrees. When the latency of the timing recovery circuit 113 is increased, the open-loop bandwidth of the timing recovery circuit 113 should be reduced to ensure that the phase margin of the timing recovery circuit 113 can be larger than 45 degrees.

As mentioned above, the timing recovery circuit 113 may have different open-loop bandwidth values for different channels and the open-loop bandwidth of the timing recovery circuit 113 should be adjusted to ensure stability of the timing recovery loop 102. The present invention therefore proposes using the loop gain calibration apparatus 104 to properly tune the open-loop bandwidth of the timing recovery circuit 113, thereby ensuring the stability of the timing recovery loop 102. Further details of the proposed loop gain calibration mechanism are described as below.

The loop gain calibration apparatus 104 is operated under a condition that a transmitter of the communication system does not provide a test signal (e.g., a sine wave with a predetermined frequency) to the receiver 100 to act as a reference signal used for calibrating the loop gain of the timing recovery loop 102. Hence, the loop gain calibration apparatus 104 is configured to perform the loop gain calibration while the receiver 100 is operating under a normal reception mode. That is, the proposed loop gain calibration and the normal data reception are performed concurrently. Therefore, the ADC 111 samples the reception signal S_{IN} received under the normal reception mode, where the reception signal S_{IN} include normal data symbols transmitted from the transmitter of the communication system. Since the proposed loop gain calibration is an on-line calibration under the normal reception mode, there is no need to particularly control the transmitter to generate and transmit a test signal.

In this embodiment, the exciting signal generator 121 is configured to generate a first exciting signal S1 and inject the first exciting signal S1 into the timing recovery loop 102 while the timing recovery loop 102 is operating in response to the reception signal S_{IN} received under the normal reception mode. The reception signal S_{IN} may be used to deliver data symbols at a specific symbol rate. For example, the specific symbol rate may be 10.3125 GHz when the communication system is a 10 Gb/s LRM fiber system. It should be noted that digital circuits may operate at a slower operation rate, say, 10.3125/M GHz due to hardware constraints. For example, the timing error detector 115 may operate at the slower operation rate, such that one timing error TE output from the timing error detector 115 is an accumulation result of M timing errors. However, this is for illustrative purposes only, and is not meant to be a limitation of the present invention. In an alternative design, the digital hardware operation rate may be equal to the symbol rate. This also falls within the scope of the present invention.

In this embodiment, the exciting signal generator 121 is used to generate a periodical signal as the first exciting signal S1. For example, the periodical signal is a sinusoidal signal with a predetermined exciting frequency. The predetermined exciting frequency may be selected by checking the phase response sensitivity among different signal frequencies. For example, when the 10 Gb/s LRM fiber system uses a large SJ (sinusoidal jitter) test with the frequency of 375 KHz, the predetermined exciting frequency should be properly set to be far away from 375 KHz.

As shown in FIG. 1, the exciting signal generator 121 adds the first exciting signal S1 to an output of the timing recovery circuit 113 through a signal combiner such as an adder 115. In this embodiment, the phase interpolator 114 generates a sampling clock with the ADC sampling phase φ to the ADC 111. Hence, the ADC sampling phase φ is adjusted by the phase interpolator 114 based on the phase of the clock CLK_{TR}. Since the output of the timing recovery circuit 113 is coupled to the phase interpolator 114, the exciting signal generator 121 may be regarded as adding the first exciting signal S1 to an input of the phase interpolator 113 through the adder 115. Hence, the ADC sampling phase φ is adjusted by the phase interpolator 114 based on the phase of the clock CLK_{TR} and the phase of the first exciting signal S1. The first exciting signal S1 adds phase disturbance to the ADC sampling phase φ. Assuming that the first exciting signal S1 is a sinusoidal signal with a fixed frequency, the ADC sampling phase φ adjusted by the phase interpolator 114 is a periodical signal.

It should be noted that the location where the exciting signal generator 121 injects the first exciting signal S1 may be adjusted, depending upon the timing recovery loop design. That is, adding the first exciting signal S1 to an NCO output or a PI input is for illustrative purposes only, and is not meant to be a limitation of the present invention.

The exciting signal extracting circuit 122 is configured to extract a second exciting signal S2 from the timing recovery loop 102 after the first exciting signal S1 is injected into the timing recovery loop 102. The phase disturbance resulting from the first exciting signal S1 injected into the input of the phase interpolator 114 will affect the ADC sampling phase φ, and will be present in the timing error TE generated from the timing error detector 115. Hence, the first exciting signal S1 will be included in the NCO output. Specifically, the output of the NCO 117 may be regarded as a combination of the clock CLK_{TR} generated due to an offset of ADC sampling of data symbols in the reception signal S_{IN} and a delayed version of the injected first exciting signal S1. In this embodiment, the first exciting signal S1 passing through circuit components in the timing recovery loop 102 is captured as the second exciting signal S2, where the phase lag between the second exciting signal S2 and the first exciting signal S1 is correlated to the timing recovery bandwidth.

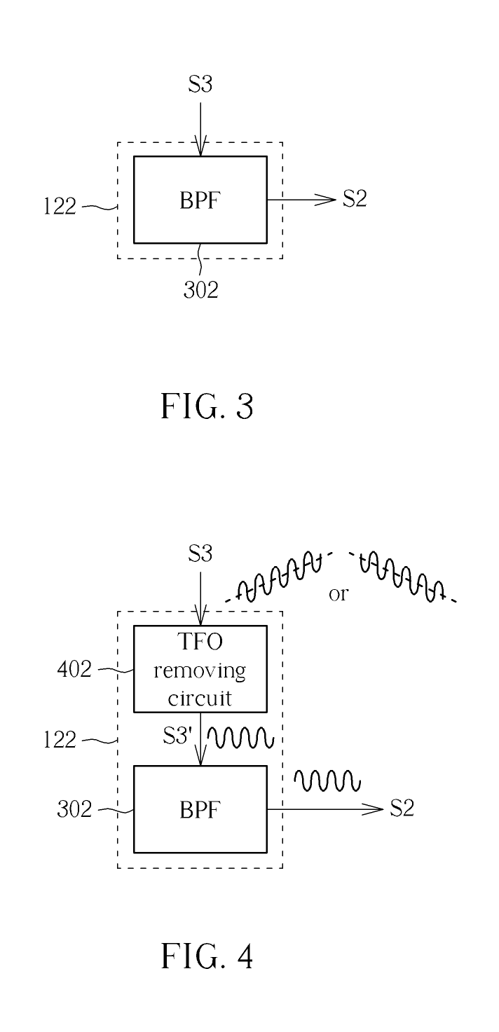

FIG. 3 is a diagram illustrating a first exemplary embodiment of the exciting signal extracting circuit 122 shown in FIG. 1. The exciting signal extracting circuit 122 may be simply implemented using a band pass filter (BPF) 302. The BPF 302 is configured to perform a predetermined filtering operation upon a signal S3 obtained from the timing recovery loop 102 to generate the second exciting signal S2. As mentioned above, the exciting frequency of the first exciting signal S1 is properly set. In this way, signal components in the signal S3 that do not belong to the first exciting signal S1 can be filtered out by the BPF 302.

In general, the transmitter of the communication system has a digital-to-analog converter (DAC) to deal with conversion between digital signals and analog signals, and the receiver 100 of the communication system has the ADC 111 to deal with conversion between analog signals and digital signals. However, the sampling frequency of receiver's ADC may not be exactly synchronized with the sampling frequency of transmitter's DAC, thus resulting in a timing frequency offset (TFO). The sampling timing offsets resulting from the TFO will be accumulated. For example, the accumulated sampling timing offset may be linearly increased or linearly decreased during a period of time. Assume that the first exciting signal S1 is a sine wave. After the first exciting signal S1 is injected to the timing recovery loop 102 to disturb the ADC sampling phase φ, an unwrapped phase will be a sine wave if there is no TFO. However, if there is TFO, the unwrapped phase will linearly increase/decrease and come with a sine wave. To obtain a correct delayed version of the first exciting signal S1, the TFO effect should be removed.

FIG. 4 is a diagram illustrating a second exemplary embodiment of the exciting signal extracting circuit 122 shown in FIG. 1. The exciting signal extracting circuit 122 may be implemented using the aforementioned BPF 302 and a TFO removing circuit 402. The TFO removing circuit 402 is configured to remove the TFO effect from the signal S3 obtained from the timing recovery loop 102 and accordingly generate a pre-processed signal S3′ to the BPF 302. The BPF 302 performs the predetermined filtering operation upon the pre-processed signal S3′ to generate the second exciting signal S2.

The loop gain control circuit 123 is configured to receive the first exciting signal S1 from the exciting signal generator 121, receive the second exciting signal S2 from the exciting signal extracting circuit 122, and control the loop gain of the timing recovery loop 102 according to the first exciting signal S1 and the second exciting signal S2. In this embodiment, the phase lag calculating circuit 124 is configured to calculate a phase lag PD between the second exciting signal S2 and the first exciting signal S1. The loop gain calibration circuit 125 is configured to adjust the loop gain of the timing recovery loop 102 according to the phase lag PD. For example, the loop gain calibration circuit 125 may adjust the loop gain of the timing recovery loop 102 by adjusting the gain of the controllable gain stage 112 and/or the gain of the loop filter 116. When at least one of the gain of the controllable gain stage 112 and the gain of the loop filter 116 is adjusted, the open-loop bandwidth and the phase margin of the timing recovery circuit 113 are adjusted correspondingly.

In this embodiment, the loop gain calibration circuit 125 may compare the phase lag PD with a target phase difference (which is set based on a target timing recovery bandwidth), and may refer to the comparison result to adjust the loop gain of the timing recovery loop 102 for making the phase lag PD approach the target phase difference. When the phase lag PD is adjusted to a value equal to the target phase difference, the timing recovery bandwidth is controlled to be the target bandwidth. In this way, the stability of the timing recovery loop 102 can be properly controlled by using the proposed loop gain calibration mechanism.

It should be noted that using the proposed loop gain calibration mechanism in a receiver of an optical fiber communication system is merely one feasible application of the present invention. Any communication system with a receiver using the proposed loop gain calibration mechanism to control timing recovery bandwidth falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A loop gain calibration apparatus, comprising:
an exciting signal generator, configured to generate a first exciting signal and inject the first exciting signal into a timing recovery loop while the timing recovery loop is operating in response to a reception signal received under a normal reception mode;
an exciting signal extracting circuit, configured to extract a second exciting signal from the timing recovery loop after the first exciting signal is injected into the timing recovery loop; and
a loop gain control circuit, configured to receive the first exciting signal from the exciting signal generator, receive the second exciting signal from the exciting signal extracting circuit, and control a loop gain of the timing recovery loop according to the first exciting signal and the second exciting signal.

2. The loop gain calibration apparatus of claim 1, wherein the exciting signal generator is configured to generate a periodical signal as the first exciting signal.

3. The loop gain calibration apparatus of claim 2, wherein the periodical signal is a sinusoidal signal.

4. The loop gain calibration apparatus of claim 1, wherein the timing recovery loop comprises an analog-to-digital converter (ADC) configured to sample the reception signal and a timing recovery circuit configured to perform timing recovery based on an ADC output; and the exciting signal generator is configured to add the first exciting signal to an output of the timing recovery circuit.

5. The loop gain calibration apparatus of claim 1, wherein the timing recovery loop comprises an analog-to-digital converter (ADC) configured to sample the reception signal and a phase interpolator configured to control an ADC sampling phase; and the exciting signal generator is configured to add the first exciting signal to an input of the phase interpolator.

6. The loop gain calibration apparatus of claim 1, wherein the timing recovery loop performs timing error detection by using a Mueller-Muller algorithm.

7. The loop gain calibration apparatus of claim 1, wherein the loop gain control circuit comprises:
a phase lag calculating circuit, configured to calculate a phase lag between the second exciting signal and the first exciting signal; and
a loop gain calibration circuit, configured to adjust the loop gain of the timing recovery loop according to the phase lag.

8. The loop gain calibration apparatus of claim 1, wherein the exciting signal extracting circuit comprises:
a filter, configured to perform a predetermined filtering operation upon a signal obtained from the timing recovery loop to generate the second exciting signal.

9. The loop gain calibration apparatus of claim 1, wherein the exciting signal extracting circuit comprises:
a timing frequency offset (TFO) removing circuit, configured to remove a TFO effect from a signal obtained from the timing recovery loop to generate a pre-processed signal; and
a filter, configured to perform a predetermined filtering operation upon the pre-processed signal to generate the second exciting signal.

10. The loop gain calibration apparatus of claim 1, wherein the loop gain calibration apparatus is part of a receiver of an optical fiber communication system.

11. A loop gain calibration method, comprising:
while the timing recovery loop is operating in response to a reception signal received under a normal reception mode,
generating a first exciting signal and injecting the first exciting signal into a timing recovery loop;
after the first exciting signal is injected into the timing recovery loop, extracting a second exciting signal from the timing recovery loop; and
controlling a loop gain of the timing recovery loop according to the first exciting signal and the second exciting signal.

12. The loop gain calibration method of claim 11, wherein generating the first exciting signal comprises:
generating a periodical signal as the first exciting signal.

13. The loop gain calibration method of claim 12, wherein the periodical signal is a sinusoidal signal.

14. The loop gain calibration method of claim 11, wherein the timing recovery loop comprises an analog-to-digital converter (ADC) configured to sample the reception signal and a timing recovery circuit configured to perform timing recovery based on an ADC output; and injecting the first exciting signal into the timing recovery loop comprises:
adding the first exciting signal to an output of the timing recovery circuit.

15. The loop gain calibration method of claim 11, wherein the timing recovery loop comprises an analog-to-digital converter (ADC) configured to sample the reception signal and a phase interpolator configured to control an ADC sampling phase; and injecting the first exciting signal into the timing recovery loop comprises:
adding the first exciting signal to an input of the phase interpolator.

16. The loop gain calibration method of claim 11, wherein the timing recovery loop performs timing error detection by using a Mueller-Muller algorithm.

17. The loop gain calibration method of claim 11, wherein controlling the loop gain of the timing recovery loop comprises:
calculating a phase lag between the second exciting signal and the first exciting signal; and
adjusting the loop gain of the timing recovery loop according to the phase lag.

18. The loop gain calibration method of claim 11, wherein extracting the second exciting signal from the timing recovery loop comprises:
performing a predetermined filtering operation upon a signal obtained from the timing recovery loop to generate the second exciting signal.

19. The loop gain calibration method of claim 11, wherein extracting the second exciting signal from the timing recovery loop comprises:
generating a pre-processed signal by removing a timing frequency offset (TFO) effect from a signal obtained from the timing recovery loop; and
performing a predetermined filtering operation upon the pre-processed signal to generate the second exciting signal.

20. The loop gain calibration method of claim 11, wherein the loop gain calibration method is employed by a receiver of an optical fiber communication system.
